(19) United States
(12) Patent Application Publication
(10) Pub. No.: US 2012/0183925 A1
(43) Pub. Date: Jul. 19, 2012

(54) Dental Hydrostatic Relief Apparatus and Method

(76) Inventor: Neal B. Gittleman, Houston, TX (US)

(21) Appl. No.: 13/008,688

(22) Filed: Jan. 18, 2011

(51) Int. Cl. A61C 8/00

(52) U.S. Cl. 433/201.1

(57) ABSTRACT

A narrow channel is provided in the abutment mating surface of a dental prosthesis undercase to allow excess dental cement to flow out of the interstitial space between the dental abutment and the overlying prosthesis. During the seating of the prosthesis the excess dental cement is channeled to and extruded from a preferred collection point for easy removal. Hydrostatic pressure and trapped gases that would tend to lift the prosthesis into a non-fitting position or form a weakened cemented bond of uneven thickness are prevented by this apparatus and method. A positive copy of the narrow channel is attached to the lingual aspect of the abutment analog of the model. A virtual hydrostatic groove and lingual shelf can be subtracted from a virtual model of undercase for manufacture using computer modeling.

Reference is made to U.S. Pat. No. 5,564,928, Retrievable cemented prosthodontic apparatus, Neal B. Gittleman, filed Oct. 15, 1996.

Reference is made to U.S. Pat. No. and 5,897,320, Hydrostatic pressure relieved abutment post, Neal B. Gittleman, filed Jun. 28, 1997.

### BACKGROUND OF THE INVENTION

The prior disclosures of the applicant describe an apparatus and method that acts to equitably distribute the loading forces with retrievable dental cement between the matching surfaces of the abutments and the internal aspect of the undercase of the final restoration. Each abutment is made with a step or shelf on the lingual face to act as a bearing surface for a removal instrument. The implant abutment is modified to include a recessed shelf with enough space between the surface of the shelf and the edge of the undercase for retrieving the prosthesis by breaking the cemented surfaces free of each other, eliminating the potential damage to both structures. Prior methods of removing cemented restorations involved hammering movements under much less control. The methods and apparatus disclosed in U.S. Pat. No. 5,564,928 in combination with an appropriate dental cement, yields a predictable technique for securing, yet retrieving the final restoration. Both references cited rely upon modification of the surface of the abutment to create a parting space between the abutment and prosthesis undercase.

Furthermore, Gittleman U.S. Pat. No. 5,897,320 taught the inclusion of a groove in the surface of the implant abutment to act as a channel in the directing of excess cement from within the intervening space between the abutment and the overlying prosthesis. This channel, by allowing excess cement to flow in a controlled manner to prearranged collection site, prevents the capture of an incompressible mass of cement that will hold the overlaying prosthesis in a lifted, malocclusive position. The channel described prevents the formation of blind pockets of dental cement that would exert an outward force and weaken the joint during solidification of the dental cement.

### BRIEF SUMMARY OF THE INVENTION

In the prior art, the hydrostatic relief channel and the recessed shelf are formed by modifying the surface of the abutment to form a recessed groove and shelf in the surface of the abutment itself, where the current application modifies the internal aspect of the prosthetic undercase. This has the commercial advantage of using unmodified abutments from many manufacturers while taking advantage of modern undercase manufacturing methods.

The steps of the method of replicating the hydrostatic groove and lingual shelf are:

1. Taking an Impression of the relevant portion of the jaw with implant in place;

2. Forming a cast model in stone with attached analog of the abutment;

3. Placing a stick-on positive model of the hydrostatic groove and lingual shelf on the lingual aspect of the analog on the stone model; and

4. Fabricating a model of the prosthetic undercase with a recessed hydrostatic groove and lingual shelf in the inner lingual wall of the internal recesses of the undercase.

Several hydrostatic relief stick-on elements can be packaged on a sheet of material for easy removal and application to the abutment analog with a pair tweezers, a placement tool, or the point of scalpel or an Xacto™ knife.

Advances in dentistry, which now include chair-side laser scanning of the teeth and surrounding tissue, result in a virtual model. The virtual model is viewed and manipulated on a computer for best fit, proper occlusion, and structural integrity. The virtual model is then sent as a computerized set of data to a dental laboratory for physical construction. Since the virtual model can be added-to and subtracted-from as virtual Boolean solids, just as if it were a physical model in the dental laboratory, a virtual model of the hydrostatic groove and lingual shelf can be subtracted from the inner mating surface of each mating portion of the lingual aspect of the virtual undercase.

For the purpose of this discussion, an undercase is understood to be the substantial bridgework mating with and joining one or more abutment and subsequently attached to the overcase. The undercase is cast or machined from a strength-bearing alloy or ceramic joining together individual abutments to strengthen and support the overcase. The overcase is the portion of the prosthesis having the aesthetic and functional synthetic teeth. Virtual, in this context, means the computerized equivalent list of surface points sufficiently close together to define the surface of a physical model. The surface defines the “skin” of the solid, much like the skin of an apple defines the surface shape of an apple. The list of surface points in space, defining the shape of the solid is transmitted to a laboratory for fabrication by an apparatus controlled by this data. Inner surfaces and recesses are also defined by this list of surface points in space.

This hydrostatic groove and lingual shelf element, as scanned, or as placed virtually, becomes a virtual computerized hollow recess within the inner surface of a virtual undercase substructure.

An hydrostatic groove and lingual shelf element need not physically exist at all, if it is rendered as a “virtual” element that can be subtracted from the inner wall of each prosthetic cavity as a placement within the computerized model space. The computerized virtual model is then sent to the lab to be rendered in metal by casting, milling, or other means. The final physical undercase returned to the practitioner has the hydrostatic relief grooves included in each undercase recess mating with each abutment.

Thus another method of providing a hydrostatic groove and lingual shelf comprises the following steps:
1. A scan is made of the prepared site and surrounding region of the implant or implants.
2. The prepared site is modeled in virtual space on a computer and displayed on the computer monitor.
3. At least one virtual model of the hydrostatic groove and lingual shelf is moved into place in virtual space by means of a computer mouse or other manipulation apparatus.
4. The virtual hydrostatic groove and lingual shelf is subtracted from the inner aspect of the lingual wall of the virtual undercase cavity. This is repeated for each virtual undercase recess.
5. The virtual model of the undercase of the prosthesis is compiled into a compatible file for transmission to the dental laboratory.
6. The dental laboratory constructs a physical undercase from the received file.

### A BRIEF DESCRIPTION OF THE DRAWINGS

FIG. 1 is a perspective view of an abutment analog with a positive hydrostatic groove and lingual shelf element attached;

FIG. 2 is a perspective view with a set of positive hydrostatic groove and lingual shelf elements attached to a sheet for individual removal and application to analogs;

FIG. 3-a, 3-b, 3-c, and 3-d, are perspective views showing an analog, a portion of the overcase with lingual aspect visible;

FIG. 4 is a right and left handed tool for removing prosthesis;

FIG. 5 is a cross sectioned view of the abutment analog and a portion of the overcase with recessed region created by hydrostatic groove and lingual shelf element; And

FIG. 6 is a perspective view of a double threaded screw shaft on a solid abutment allowing the screw to be started in one of two positions; and

FIG. 7 is a cut away view of the double threaded screw shaft of the solid abutment.

### DETAILED DESCRIPTION OF THE DRAWINGS

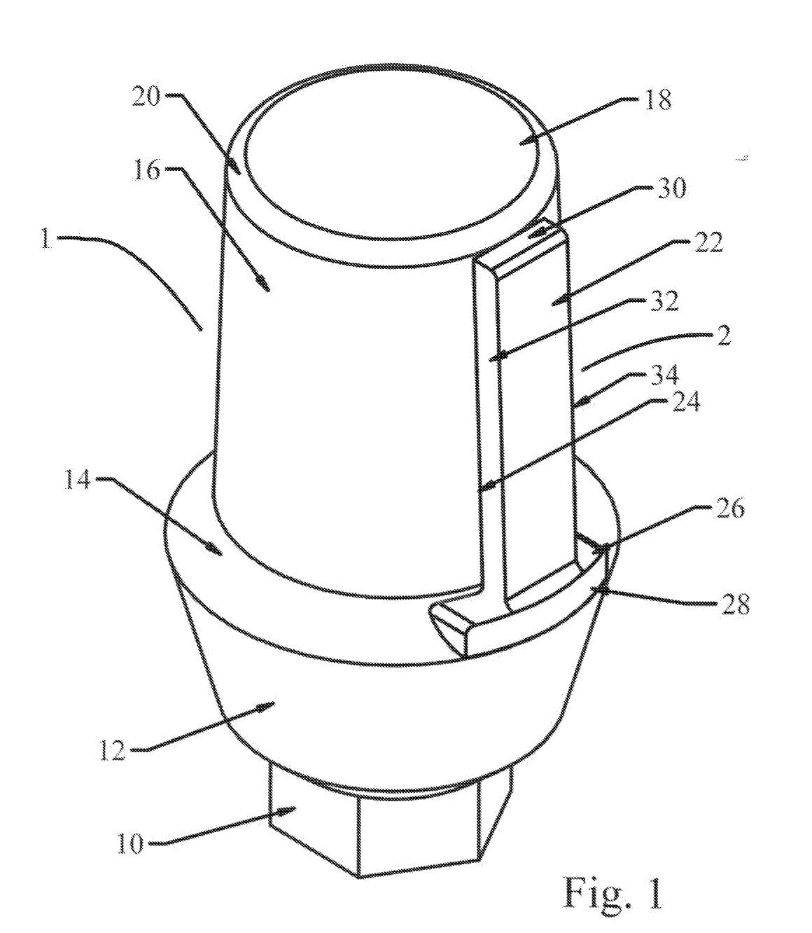

FIG. 1 is a perspective view of a screw retained abutment 1 with the hydrostatic groove and lingual shelf element 2 attached. The abutment is comprised of a coronal rim 20 of a tapered conical section 16 a flared region 14, a gingival flared region 12, and a hexagonal prism clocking region 10. A through hole 18 for a mounting screw (not shown) retains the abutment within an implant having a mating hexagonal recess and threaded recess. The hexagonal prism and hexagonal recess allow the abutment to be placed in one of six clocked positions.

A hydrostatic groove and lingual shelf element 2 is comprised of columnar region having an external face 22 with sides 32 and 34, and top 30 forming a positive model of the hydrostatic relief groove. Lingual shelf element 26 having a front face 28 is combined with the hydrostatic groove element. The hydrostatic groove and lingual shelf element become a groove and shelf in an undercase of each abutment recess in the prosthesis.
Thus this dental apparatus combines a hydrostatic groove element and lingual shelf element having a columnar region with an external face, sides and top forming a positive model of a hydrostatic relief groove and a lingual shelf element combined with the hydrostatic groove element; said hydrostatic groove element and said lingual shelf element, treated to temporarily adhere to the surface of an a dental implant abutment or an analog of the abutment, thereby becoming a hydrostatic relief groove space and a lingual shelf relief space in an at least one abutment recess in the undercase of the prosthesis during fabrication.

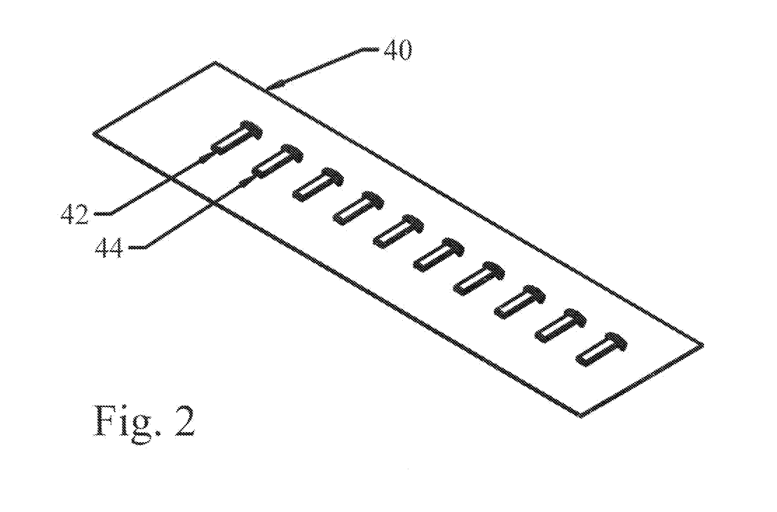

FIG. 2 shows several adhesive backed hydrostatic groove and lingual shelf elements 42 and 44 placed on a easy release sheet 40. These parts are pick up with a scalpel or Xacto™ knife, or a pair of tweezers and attached to the lingual aspect of the abutment.
Thus, this dental apparatus combines at least one said hydrostatic groove element and lingual shelf element in combination removably adhered to a carrier sheet.

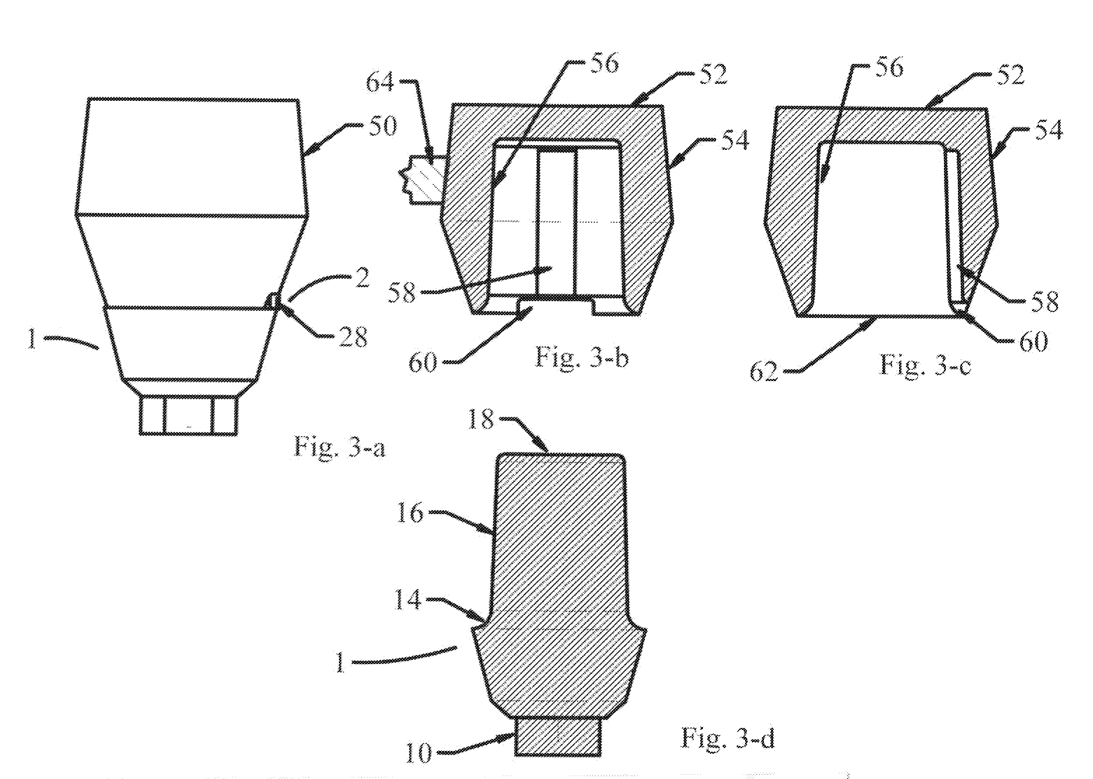

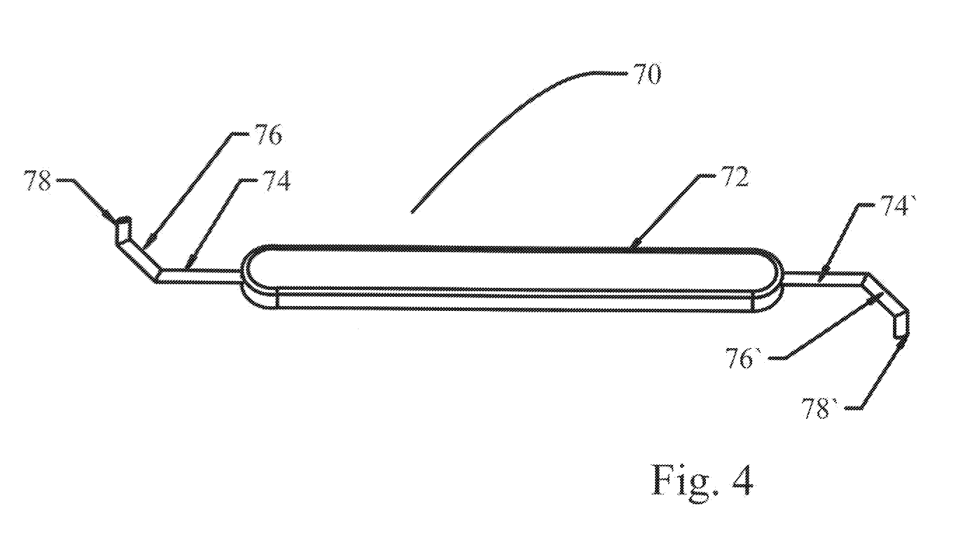

FIG. 3-a shows an elevated view of the mesial surface of an abutment 1 mated with an undercase 50. The front face portion 28 of the hydrostatic groove and lingual shelf element 2 is visible. FIG. 3-b is a sectioned elevated view of the undercase seen from the buccal side. Groove 58 is recessed into the inner lingual wall of the undercase. Lingual window 60 penetrates the lingual wall at the margin 62 providing an egress for excess cement to flow. The inner mating recess 56 fit over an abutment allowing for a thin glue or cement interface. Outer surfaces 52 and 54 are mated with the prosthesis overcase made in a cosmetically pleasing acrylic or porcelain. The groove and window direct excess cement to the easily cleaned lingual region. Hydrostatic lift caused by an excess of cement or trapped air in the cement is vented. Subsequent removal of the undercase, if necessary for repair, is achieved by the removal of a portion of the cement from the lingual window for the introduction of a parting tool (See FIG. 4.) FIG. 3-c is a sectioned elevated view of the undercase viewed from the mesial side. The hydrostatic relief recess 58 and the shelf region 60 are formed by the hydrostatic groove and lingual shelf element upon manufacture of the undercase. Bridge link 64 is partly shown and is understood to connect to other similar undercase portions 50 that mate with at least one abutment. For a single prosthetic cap, this bridge is omitted. A typical abutment 1 is shown in FIG. 3-d having a top 18 a conical side 16 a flared shelf region 14, and a hexagonal implant mating projection 10. In the case of a solid abutment hexagonal projection 10 is replaced with a threaded shaft that mates with an internal threaded recess in an implant and the hexagonal projection is replace with a tapered cone.

FIG. 4 shows a perspective view of a handheld tool 70 for the levered removal of a cemented overcase having at least one hydrostatic groove and lingual window. Handle 72 has dual ends 74 and 74′ with respective offset angled regions 76 and 76′ terminating in prying tips 78 and 78′. The two ends allow the practitioner to reach all lingual windows and apply a careful twisting force to part the cement interface.

Thus, this dental apparatus comprises a handheld tool having a left handed end and a right handed end, the left handed end reaching a number of lingual abutment surfaces, and the right handed end reaching a number of opposing lingual abutment surfaces to conveniently pry and release each abutment from the undercase of the prosthesis.

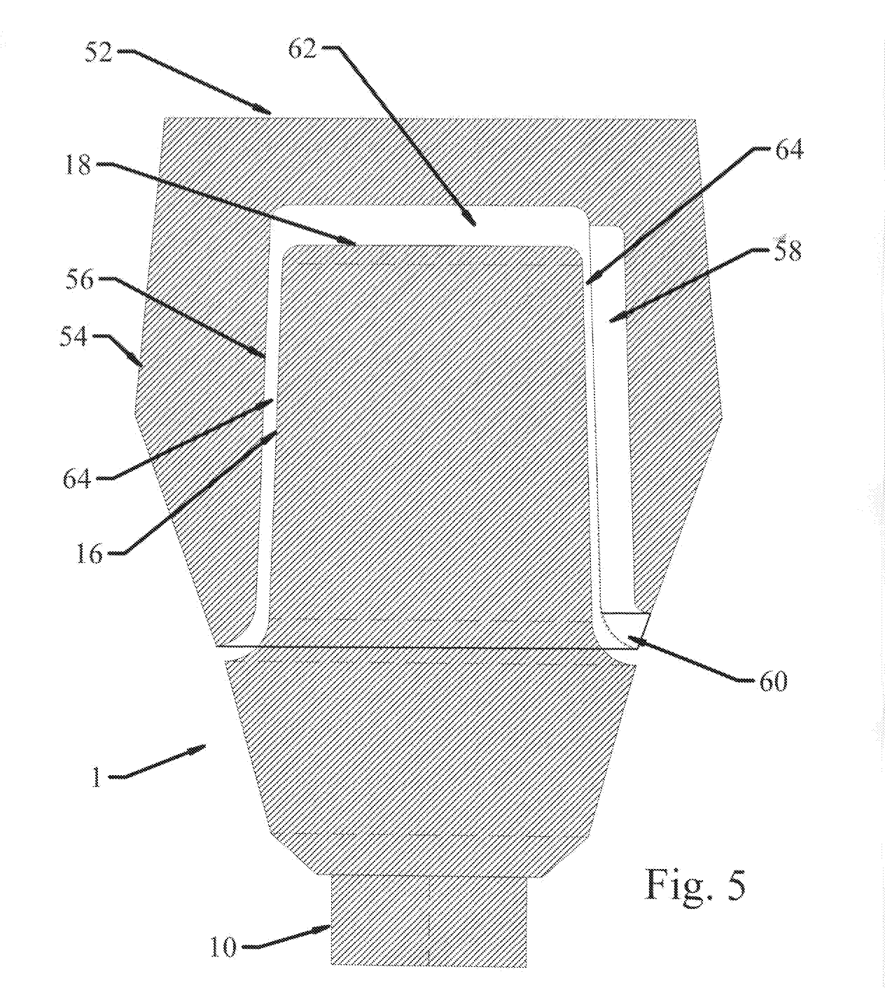

FIG. 5 shows a cross section of the abutment analog 1 situated within a recessed portion of the undercase. The conical surface 16 of the abutment mates with conical recess surface 56 leaving a thin cement gap 64. A similar cement space 62 over the abutment analog top 18 will be filled with cement. Any excess cement is expressed through the channel 58 and out through opening 60 in the undercase recess as the prosthesis is seated.

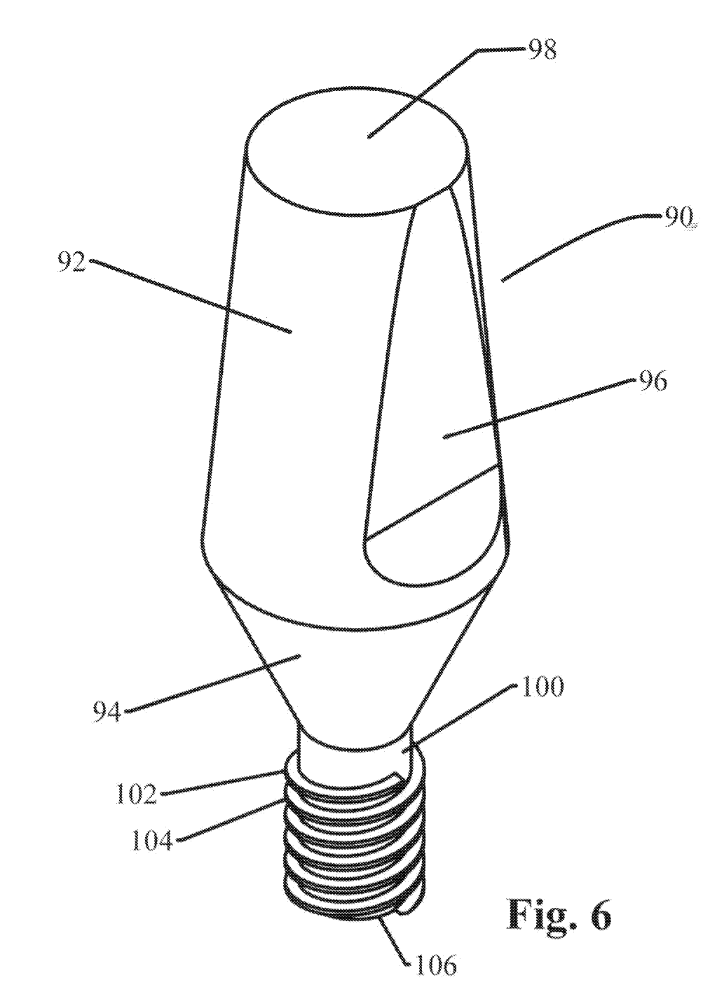

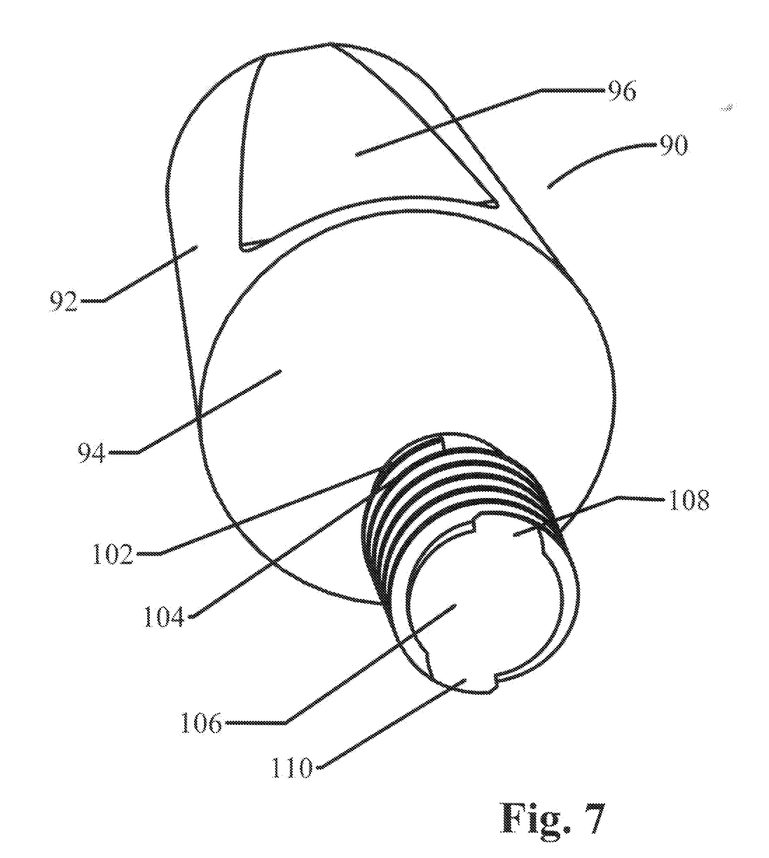

FIG. 6 details a one-piece, solid body abutment 90 having, a coronal surface 98, a conical top region 92 with an anti-rotational flat surface 96, a conical neck region 94, and a cylindrical shaft 100 with dual threads 102 and 104 terminating at apical end 106. Threads 102 and 104 spiral in the same direction as two parallel ridges. The starts of each thread at the apical end 106 are 180 degrees apart. FIG. 7 details the start of each thread 108 and 110. A matching recess with internal dual threads located within the coronal end of a dental implant allows the abutment to be started in two separate positions. The flat 96 will end up in one of two diametrically opposed positions, depending upon which abutment thread is started in which implant thread. If the abutment threads into the implant have the flat surface 96 in a lingual position which will interfere with the placement of the hydrostatic groove and lingual shelf element, the abutment can be started in the opposite implant threads. In this manner, the flat can always be repositioned away from the lingual area. A mark or marks on the abutment can distinguish the start of either of the two threads. A single dot can mark the beginning of the first thread, while two dots can mark the start of the second thread. While two threads, with diametric starts are shown, it is understood that additional parallel threads are within the scope of this application. Other starting angles other than 180 degrees are anticipated by this application.

The starting points on the screw threads are at the opposite sides of the shaft. They represent a dual thread that can be started in two diametric positions. If a flat on single-piece abutment would fall on the lingual side and interfere with the hydrostatic groove the thread can be started alternately to place the flat on the opposing side. Suitable markings on the abutment to indicate the proper clocking are also included.

The hydrostatic groove and lingual shelf can be modeled separately or in combination as described by applicant. Modifications to the shape and size of the hydrostatic groove and lingual shelf element, either singly or together, are anticipated for each style of abutment from varying manufacturers.

It is understood that the method of manufacture of the internal relief groove and parting shelf within at least one inner recess of the prosthesis can be formed by one of the following processes:

A region of the mouth having implants installed is prepared with abutments or abutment analogs. Physical positive models of the hydrostatic groove and lingual shelf element are attached to the appropriate lingual region of the abutment or abutment analog. An impression is taken to allow a casting of a laboratory stone model of the prepared region. A waxed up model of the undercase is built to create a template for lost wax casting of the undercase. The cast undercase is further modified with a porcelain or acrylic overcase to present an aesthetic replica of natural teeth and gums.

A second method prepares the region of interest in the mouth with the abutments or abutment analogs in place. Physical hydrostatic groove and lingual shelf elements are attached to the lingual face of each abutment or analog. An optical, three-dimensional scan is taken of the region of interest and a virtual model of the mouth is created using suitable modeling software on a chair side computer system having the optical scanner attached thereto. The virtual model is then manipulated to create a virtual model of the undercase and overcase with a hydrostatic groove and a lingual shelf at each relevant position. The virtual model is sent by electronic communication for fabrication.

A third method prepares the region of interest in the mouth with abutments or analogs in place. A scan is taken to create a virtual model If the region of interest. Virtual hydrostatic groove and lingual shelf elements are placed on the virtual lingual aspects of each virtual abutment or abutment analog. A virtual model of the undercase and overcase are created including the subtraction of a virtual hydrostatic groove and lingual shelf element from each virtual model abutment mating recess. A physical undercase is manufactured from the coordinates of each closely spaced point on the virtual model. The physical model can be machined under computer control. Structural metal alloys or ceramics like zirconia can be used. Alternately, a wax or plastic buildup of a core for “lost wax” casting of the physical undercase can be made using “rapid prototyping” equipment. The wax or plastic core is “burned out” of a mold through vents and sprues and molten metal is poured into the now empty mold cavity. Upon cooling the mold is broken apart to reveal the undercase casting.

Since computer controlled milling apparatus has reached a level of replication matching that of a final fit for a prosthesis, and manufacturing facilities exist to offer a quick turn around time at reasonable cost, this is becoming the preferred method of manufacture. The practicing dentist, sends his scanned results, after his review and minor modifications, all done in the virtual software realm, to a distant laboratory as an email attachment. The laboratory constructs his undercase (with or without the overcase) and returns a completed prosthetic for a final installation. In the case of screw retained abutments, the prosthesis is attached to each abutment through the occlusal surface at each site and the hole through the occlusal surface is repaired. A cemented prosthesis is simpler to install and with the hydrostatic groove and lingual shelf easier to remove, if necessary.
Thus this dental apparatus comprises a virtual hydrostatic groove element and a virtual lingual shelf element having a virtual columnar region with an external face, and sides, and top forming a virtual positive model of a virtual hydrostatic relief groove combined with a virtual lingual shelf element. The virtual hydrostatic groove element and the virtual lingual shelf element are virtually subtracted from a virtual undercase abutment recess space surface, by software means, thereby becoming a real hydrostatic relief groove space and a real lingual shelf space in an at least one abutment recess in the real undercase of the prosthesis during fabrication.

1. A dental apparatus comprising a hydrostatic groove element and lingual shelf element having a columnar region with an external face, and sides, and top forming a positive model of a hydrostatic relief groove;
said lingual shelf element in combination with said hydrostatic groove element; said hydrostatic groove element and said lingual shelf element, treated to temporarily adhere to the surface of an a dental implant abutment, thereby becoming a hydrostatic relief groove space and a lingual shelf relief space in an at least one abutment recess in the undercase of the prosthesis during fabrication.

2. A dental apparatus, as in claim 1, comprising a hydrostatic groove element and lingual shelf element having a columnar region with an external face, and sides, and top forming a positive model of a hydrostatic relief groove; said lingual shelf element in combination with said hydrostatic groove element; said hydrostatic groove element and said lingual shelf element, treated to temporarily adhere to the surface of an a dental implant abutment analog, thereby becoming a hydrostatic relief groove space and a lingual shelf relief space in an at least one abutment recess in the undercase of the prosthesis during fabrication.

3. A dental apparatus, as in claim 1, comprising at least one said hydrostatic groove element and lingual shelf element in combination removably adhered to a carrier sheet.

4. A dental apparatus comprising a handheld tool having a left handed end and a right handed end, said left handed end reaching a number of lingual abutment surfaces, and said right handed end reaching a number of opposing lingual abutment surfaces to conveniently pry and release said abutment from said undercase of the prosthesis.

5. A dental apparatus, as in claim 1, comprising a virtual hydrostatic groove element and virtual lingual shelf element having a virtual columnar region with an external face, and sides, and top forming a virtual positive model of a virtual hydrostatic relief groove and said virtual lingual shelf element in combined with the virtual hydrostatic groove element; said virtual hydrostatic groove element and said virtual lingual shelf element, virtually subtracted from the undercase abutment recess space surface, thereby becoming a hydrostatic relief groove space and a lingual shelf relief space in an at least one abutment recess in the undercase of the prosthesis during fabrication.

6. A dental apparatus comprising a threaded shaft having at least two threads, said shaft threading into said implant abutment, said at least two threads starting in at least one position to insure said hydrostatic groove element and said lingual shelf element in combination thereby have a compatible mating lingual surface on said implant abutment.

7. A dental apparatus, as in claim 1, comprising a virtual hydrostatic groove element and a virtual lingual shelf element having a virtual columnar region with an external face, and sides, and top forming a virtual positive model of a virtual hydrostatic relief groove combined with a virtual lingual shelf element; said virtual hydrostatic groove element and said virtual lingual shelf element are virtually subtracted from a virtual undercase abutment recess space surface, thereby becoming a real hydrostatic relief groove space and a real lingual shelf space in an at least one abutment recess in the real undercase of the prosthesis during fabrication.
